(19) United States
(12) Patent Application Publication
(10) Pub. No.: US 2003/0028473 A1
(43) Pub. Date: Feb. 6, 2003

(54) Distributed method for bid evaluation in procurement auctions with piece-wise linear supply curves

(75) Inventors: Marta Eso, Peekskill, NY (US); Jayant Kalagnanam, Tarrytown, NY (US); Laszlo Landanyi, Peekskill, NY (US)

Correspondence Address: Ryan, Mason & Lewis, LLP, 90 Forest Avenue, Locust Valley, NY, 11560, US

(73) Assignee: International Business Machines Corporation, Armonk, NY

(21) Appl. No.: 10/188,267

(22) Filed: Jul. 2, 2002

Related U.S. Application Data
(60) Provisional application No. 60/303,629, filed on Jul. 6, 2001.

(51) Int. Cl. G06F 17/60

(52) U.S. Cl. 705/37

(57) ABSTRACT

A method for evaluating bids. The method in accordance with the present invention includes the steps of obtaining at least one bid from a supplier, wherein the bid comprises data indicating a quantity of a commodity to be supplied and a cost of supplying the commodity, generating at least one supply pattern from the bid, and computing a cost associated with the supply pattern, wherein the cost is computed as a sum of costs for each commodity as specified by the supply patterns.

### CROSS REFERENCE TO RELATED APPLICATION

This application claims priority to the U.S. provisional patent application identified by Ser. No. 60/303,629, filed on Jul. 6, 2001, the disclosure of which is incorporated by reference herein.

### FIELD OF THE INVENTION

The present invention relates generally to techniques for bid evaluation in procurement auctions and, more particularly, to techniques for bid evaluation when the bids consist of additive separable supply curves so that the supply curves for individual commodities are piece-wise linear.

### BACKGROUND OF THE INVENTION

Reverse auctions are private marketplaces operated by buyers who wish to procure large quantities of heterogeneous products. A problem which is commonly faced by the buyer is the evaluation of the bids which are submitted by the suppliers. That is, the buyer must determine the amount of each of the commodities to purchase from each supplier so that the buyer's demand is satisfied in the most economical way possible. Depending on actual market factors, the bid evaluation problem needs to be solved every time a new bid is submitted, or it may be solved periodically, after collecting bids for a given amount of time. The winning bids are realized as trades after the auction is over.

In addition to the underlying goals of meeting the demand and minimizing the total purchase price, the buyer may impose additional business and/or operational requirements that the selected bids must satisfy. Examples of such requirements include: (i) upper and lower limits on the number of suppliers so that the buyer does not rely on too few suppliers or increase his/her overhead cost by managing too many supplier accounts; (ii) upper and lower limits on the amount of goods purchased from each supplier, typically specified separately for each commodity as well as for a total amount provided by a given supplier; and (iii) minimum average quality requirements on chosen suppliers (such as a measure of reliability, or environmental or labor practices). While bid evaluation itself is a computationally difficult problem, these additional business and/or operational requirements make it even more challenging. The requirements vary with factors such as the particular industry considered, the individual buyer, the stage of the negotiation at which the auction takes place and the individual suppliers.

Prevailing practice is to rank the bids based on some criteria and then evaluate the ranking “by hand” (as in a typical request for quote (RFQ)). However, this evaluation method may not even guarantee feasibility, let alone a solution of acceptable quality. Therefore, a need exists for a method which evaluates bids in accordance with requirements set by a requester of the bids, in such complex settings as described above.

### SUMMARY OF THE INVENTION

The present invention applies to a marketplace operated by a buyer who wishes to procure a quantity of heterogeneous products. In response to requests for proposals from the buyer, suppliers submit price curves (bids) for each of the commodities, indicating the price charged as a function of the purchased quantity. The total amount paid to a supplier is computed as the sum of the prices charged for the individual commodities. Piece-wise linear supply curves are generated from the submitted price curves.

A central decision problem faced by the buyer is the evaluation of the bids. That is, the buyer must determine the amount of each of the commodities to be purchased from each supplier, so that the buyer's demand is satisfied as economically as possible. In addition to meeting the demand, the buyer may impose business rules that result in a very challenging bid evaluation problem. Depending on the actual market mechanism, the bid evaluation problem may need to be solved every time a new bid is submitted or to be solved periodically, after collecting bids for a given amount of time.

This invention introduces the notion of supply patterns that lead to a novel mathematical formulation for the buyer's decision problem in this marketplace. In one embodiment of the invention, an iterative distributed method for solving this mathematical model is provided. Another embodiment of the invention provides a quality guarantee for the solution obtained.

In one aspect of the present invention, a method for evaluating bids includes the steps of obtaining at least one bid from a supplier, wherein the bid comprises data indicating a quantity of a commodity to be supplied and a cost of supplying the commodity, generating at least one supply pattern from the bid, and computing a cost associated with the supply pattern, wherein the cost is computed as a sum of costs for each commodity as specified by the supply patterns.

### BRIEF DESCRIPTION OF THE DRAWINGS

The features of the present invention will become apparent from the following detailed description, taken in conjunction with the accompanying drawings, wherein:

FIG. 1 is a block diagram illustrating a private marketplace operated by a buyer;

FIG. 2 is a graphical representation illustrating how a unit price curve is transformed into a piece-wise linear curve for the total price;

FIG. 3 is a graphical representation illustrating a general piece-wise linear function having discontinuities;

FIG. 4 is a graphical representation illustrating an approximation of a general function with a family of piece-wise linear functions;

FIG. 5 illustrates a set of supply patterns corresponding to a supplier's bid;

FIG. 6 is a flow diagram illustrating the process flow of formulating the full model using the supply patterns;

FIG. 7 is a flow diagram illustrating a high level outline of the distributed procedure for solving the above model;

FIG. 8 is a flow diagram illustrating the process flow of the Master problem;

FIG. 9 is a flow diagram illustrating the process flow of the Integer Solution Heuristics of FIGS. 7 and 8;

FIG. 10 is a flow diagram illustrating the process flow of the supply generation subroutine for a given supplier;

FIG. 11 is a flow diagram illustrating the steps to formulate the mathematical model for finding a surplus maximizing supply pattern;

FIG. 12 is a flow diagram illustrating the steps to be taken to linearize the above mathematical model;

FIG. 13 is a line chart depicting the relationship between various solution values during the iterative solution procedure;

FIG. 14 is a flow diagram illustrating a method of computing the lower bound for the full relaxed master problem; and

FIG. 15 is a block diagram illustrating a computer system for performing the methods and techniques of bid evaluation in accordance with the present invention.

### DETAILED DESCRIPTION OF THE PREFERRED EMBODIMENT

The following terms, as used herein, are intended to have the following definitions. A single buyer wishes to purchase Qₖ units of K heterogeneous commodities indexed by k. N suppliers, indexed by j=1, . . . , N, each submit bids that consist of a price-quantity curve p^{j} : [symbol] ^{K}→ [symbol] . This function specifies the price that a supplier will charge for any K-tuplet of quantities from the commodities.

The following assumptions are also used herein. First, supplier curves are additive separable; that is, p^{j}(xₗ, . . . ,x_{K})=Σₖpₖ^{j}(xₖ),where pₖ^{j}: [symbol] → [symbol] are individual price curves submitted by suppliers for each of the commodities separately. Second, each individual price curve pₖ^{j} is a piece-wise linear function.

The term “additive separability” assumes that prices for commodities are independent. This assumption is not unusual in long-term strategic sourcing where the demanded (and thus supplied) quantities are very large. The piece-wise linearity of the individual supply curves is a minor restriction since piece-wise linear supply curves frequently arise in practical applications (e.g., volume discount or marginal price curves). Moreover, a general price curve can be approximated by a family of piece-wise linear functions. Accordingly, a method in accordance with an embodiment of the present invention can be applied for approximate bid evaluation for general supply curves. The bid evaluation problem faced by the buyer is to determine how much of each commodity to buy from each supplier so that the demand is satisfied in the most economical way possible.

This invention introduces the notion of supply patterns that lead to a novel mathematical formulation to resolve the buyer's decision problem. In accordance with an illustrative embodiment of the present invention, an iterative distributed method for solving the so created mathematical model is described. A method in accordance with an embodiment of the present invention ensures that the solution obtained by the method is of provable quality.

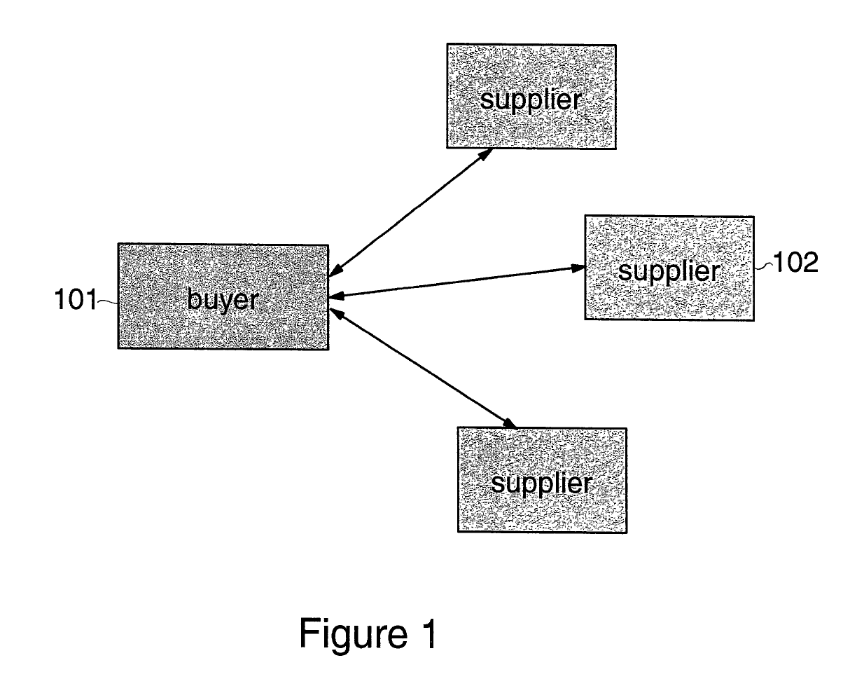

Referring now to the drawings in detail, FIG. 1 is a block diagram illustrating a private marketplace operated by a buyer 101. In accordance with the marketplace structure illustrated in FIG. 1, the buyer 101 has several responsibilities. First, buyer 101 decides which goods he/she needs to purchase. Once that decision has been made, buyer 101 solicits and receives bids from suppliers 102. Each bid is evaluated and the successful bidder is notified. Therefore, as shown in FIG. 1, one or more suppliers 102 submit price curves for each of the commodities indicating the price charged as a function of the purchased quantity. The total amount paid by a buyer 101 to a supplier 102 is therefore computed as the sum of the prices charged for the individual commodities. Accordingly, the supply curves are additive separable. It is assumed that the submitted supply curves are piece-wise linear. Preferably, the suppliers are screened prior to submitting bids.

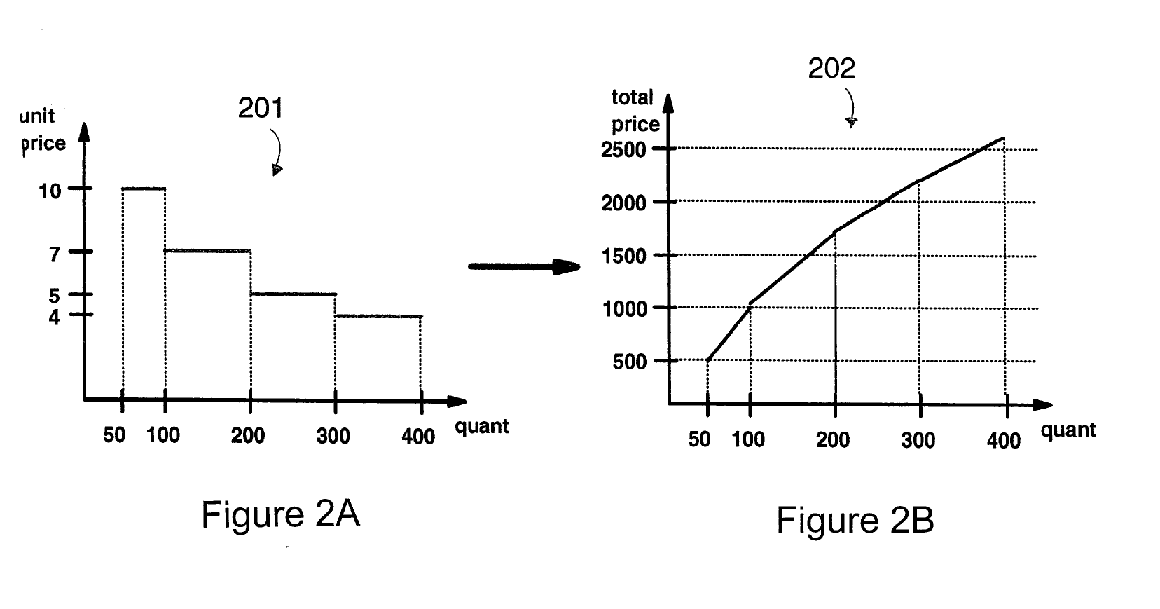

Piece-wise linear supply curves arise in various practical settings. For example, procurement auctions with “marginal price” curves (also called “volume discount” curves) are common practice in the industry for long-term strategic sourcing. Marginal price curves can be represented by decreasing step functions for the unit price in terms of the purchased quantity, as illustrated in FIG. 2A. The unit price curve translates to a piece-wise linear function for the total price in terms of the purchased quantity as illustrated in FIG. 2B. The total price at a given quantity is the area under the unit price curve up to this point; that is, the total price curve is the integral of the unit price curve.

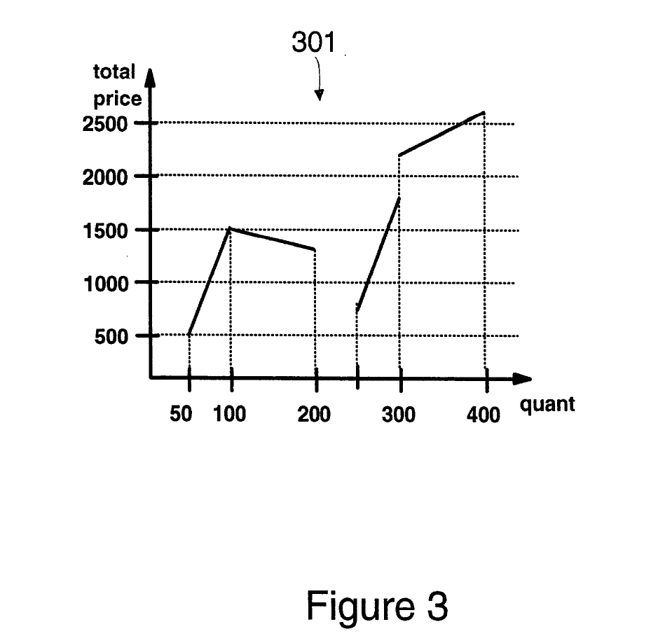

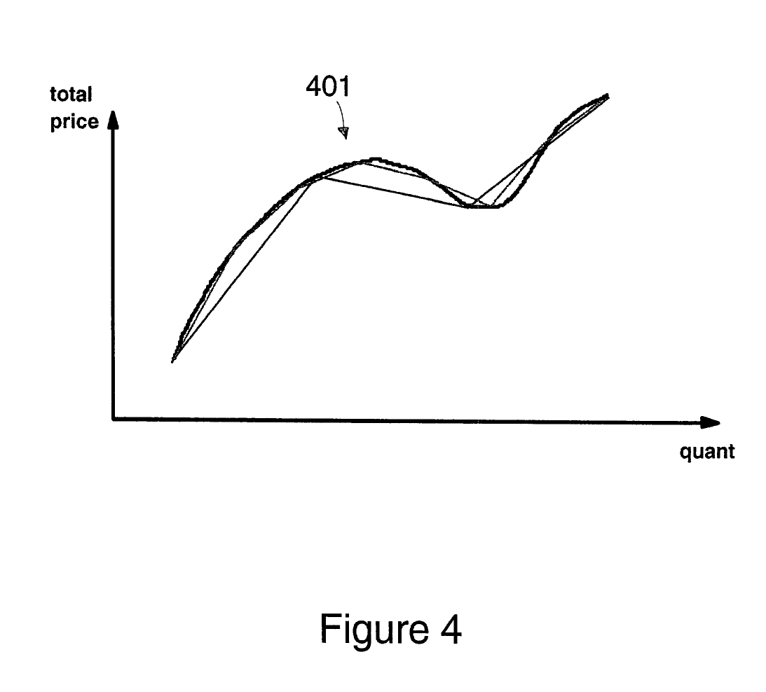

Although the piece-wise linear function is continuous and has positive slopes, discontinuity and negative slopes, which can account for production constraints at the supplier side, may appear in general piece-wise linear functions as illustrated in FIG. 3. Also, any general price curve can be approximated by a family of piece-wise linear functions as illustrated in FIG. 4. Three different lines are illustrated in the graph shown in FIG. 4. The three lines represent the general price function, a coarse approximation and a fine approximation. The approximation can be arbitrarily refined by considering piece-wise linear functions with more and more breakpoints. Thus, the techniques presented herein may be used for approximate bid evaluation with general price functions.

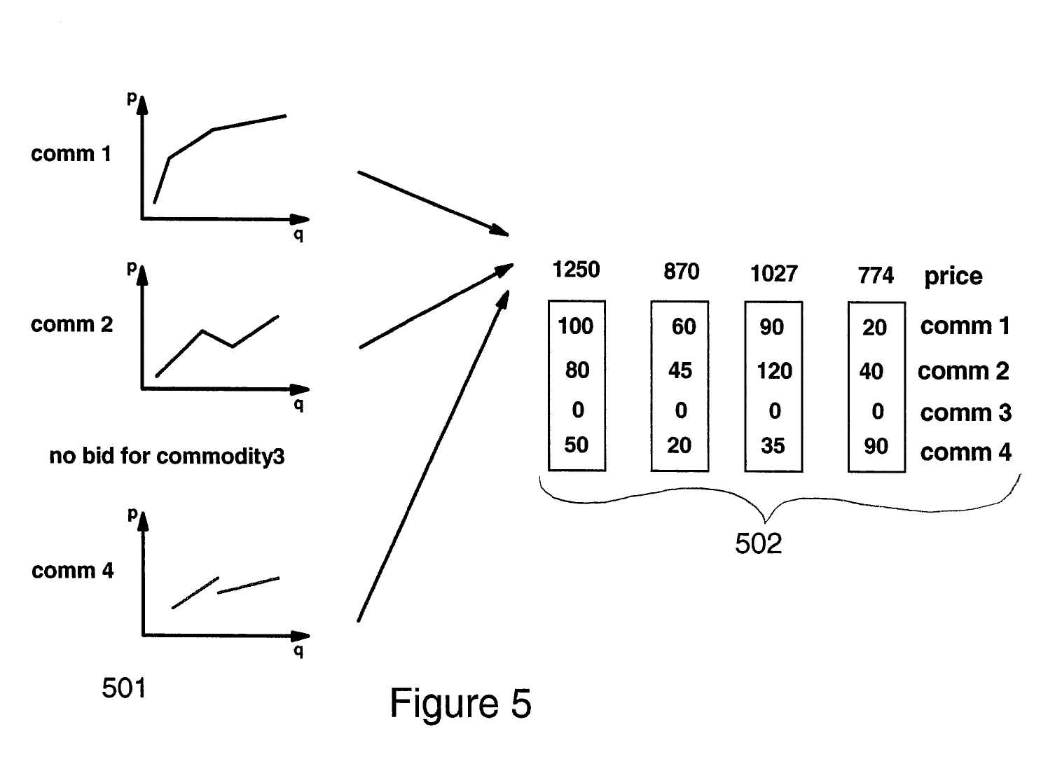

FIG. 5 illustrates a set of price versus quantity curves associated with a supplier's bid 501 for various exemplary commodities comm1 through comm4, and a corresponding set of supply patterns 502. The first step towards formulating a mathematical model in accordance with an illustrative embodiment of the present invention, is to establish a set of supply patterns 502 for each supplier. For a given supplier, the supply patterns 502 corresponding to this supplier specify the quantity of each commodity supplied and the total cost (price) of supplying these quantities. A supply pattern s is a vector, where s=(aₗ^{s}, . . . , a_{K}^{s}). A pattern is acceptable to the buyer if the pattern satisfies each of the buyer requirements imposed on the supplier. The set of supply patterns for supplier j is denoted by S^{j} and the cost of pattern sεS^{j} is computed as p^{j}(s)=Σₖpₖ^{j}(aₖ^{s}).

The following represents an example of a business requirement that a pattern may need to satisfy in order to be accepted. Let lₖ^{j} and uₖ^{j} be lower and upper limits, respectively, on the amount of commodity k that can be purchased from supplier j, and L^{J} and U^{j} are lower and upper limits for supplier j across all commodities. Accordingly, any acceptable pattern sεS^{j} must satisfy the following constraints:

lₖ^{j}≦aₖ^{s}≦uₖ^{l}, k=1, . . . ,K, and

L^{J}≦Σₖaₖ^{s}≦Uⱼ.

All acceptable patterns for the suppliers are included in the mathematical model. However, there may be an exponential number of supply patterns which makes their explicit enumeration impractical. These considerations will be described in further detail below.

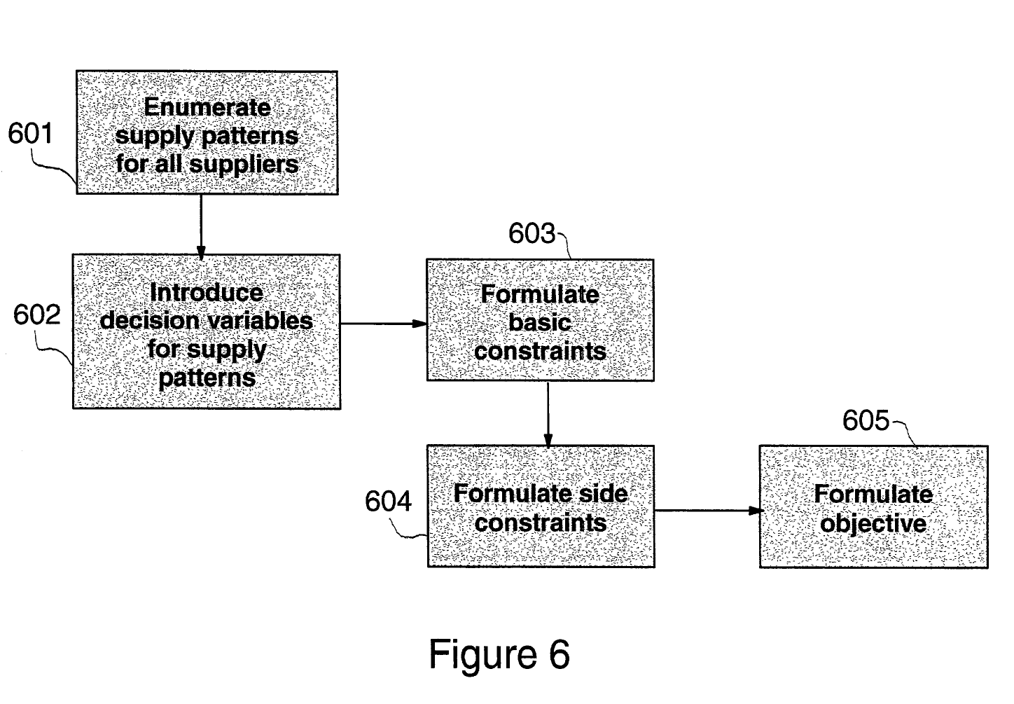

Referring now to FIG. 6, a flow diagram for formulating a mathematical model for use in resolving a buyer's decision problem is illustrated in accordance with an embodiment of the present invention. FIG. 6 illustrates the steps of creating the mathematical model. The steps include enumerating the supply patterns for all suppliers 601, introducing decision variables for the supply patterns 602, formulating the basic constraints 603, formulating the side constraints 604 and formulating the objective 605.

After enumerating the supply patterns for each of the suppliers in step 601, the next step 602 is to introduce decision variables for the supply patterns of all suppliers. It is assumed that y^{s}, sΣS^{j} is a binary (0-1) decision variable indicating whether pattern s is selected or not for supplier j,j=1, . . . ,N.

The next two steps, 603 and 604, involve formulating constraints associated with the mathematical model. The first set of constraints are referred to as “basic constraints.” This set consists of “demand constraints” that ensure that the buyer's demand is met, and “supplier constraints” that ensure that at most one pattern is selected for each of the suppliers. The demand and supplier constraints are illustrated by the following equations.

$${\sum }_{j} {\sum }_{s ∈ {S}^{′}} {a}_{k}^{s} {y}^{2} \geq {Q}_{k} , k = 1 , … , K ; and$$

$${\sum }_{s ∈ {S}^{′}} {y}^{s} \leq 1 , j = 1 , … , N .$$

The second set of constraints, formulated in step 604, is referred to as “side constraints.” These constraints incorporate additional business rules that apply to a group of suppliers. For instance, a lower and upper limit for the total number of accepted suppliers is imposed by the following constraint (in conjunction with the supplier constraints):

$$L \leq {\sum }_{j} {\sum }_{s ∈ {S}^{′}} {y}^{s} \leq U .$$

After formulating the constraints in steps 603 and 604, an objective is formulated in step 605. The objective function of minimizing the buyer's cost completes the mathematical model and is illustrated by the following equation.

$$z = min {\sum }_{j} {\sum }_{s ∈ {S}^{′}} {p}^{j} ( s ) {y}^{s} .$$

The above defined model is referred to herein as the full integral model, since all supply patterns are present in the formulation and the variables are integral (0-1). However, two properties (i.e., having too many supply patterns to enumerate before optimization and the integrality requirement on the variables) make the solution of this model difficult to compute. The solution method described in this invention addresses both of these issues. To overcome the difficulty of producing an integral solution, the decision variables are replaced by continuous variables that can take any value between 0 and 1. Additionally, integral solutions are obtained by the repeated application of Integer Solution Heuristics.

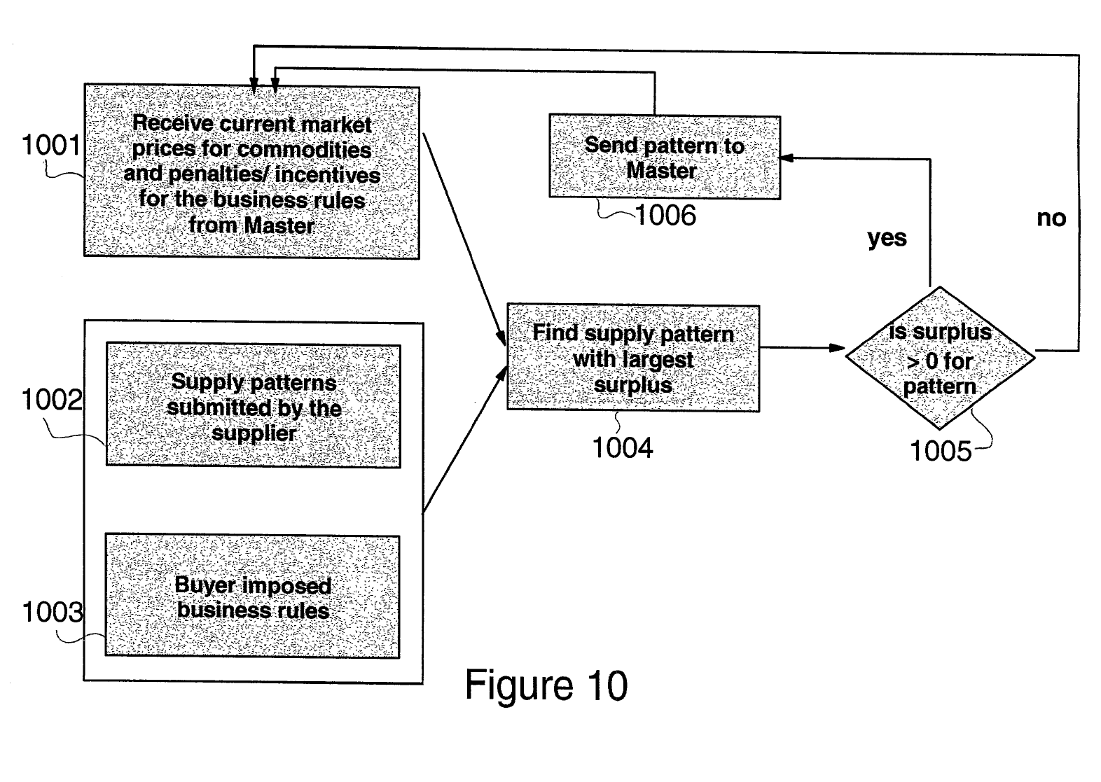

The formulation with the continuous variables is called the full relaxed model (as the integer variables are relaxed into continuous variables). Having too many supply patterns in the full relaxed model is handled through a distributed approach that iterates solving a current relaxed model with only a subset of the supply patterns and generating new supply patterns based on its results. The process of solving the current relaxed model is referred to as the Master process, while the supply patterns are generated by Pattern Generation Agents (for each supplier separately), discussed further below in conjunction with FIG. 10. Note that the Pattern Generation Agents are subroutines that do not communicate with the suppliers. The cost-minimizing solutions to the relaxed models (full or current) may contain patterns that have a fractional value in the solution, and are referred to as fractional-valued patterns. This is in contrast to integer-valued patterns that participate in the solution with a value of one. The following description provides a high level outline of the iterative procedure referred to above and then provides details about each step.

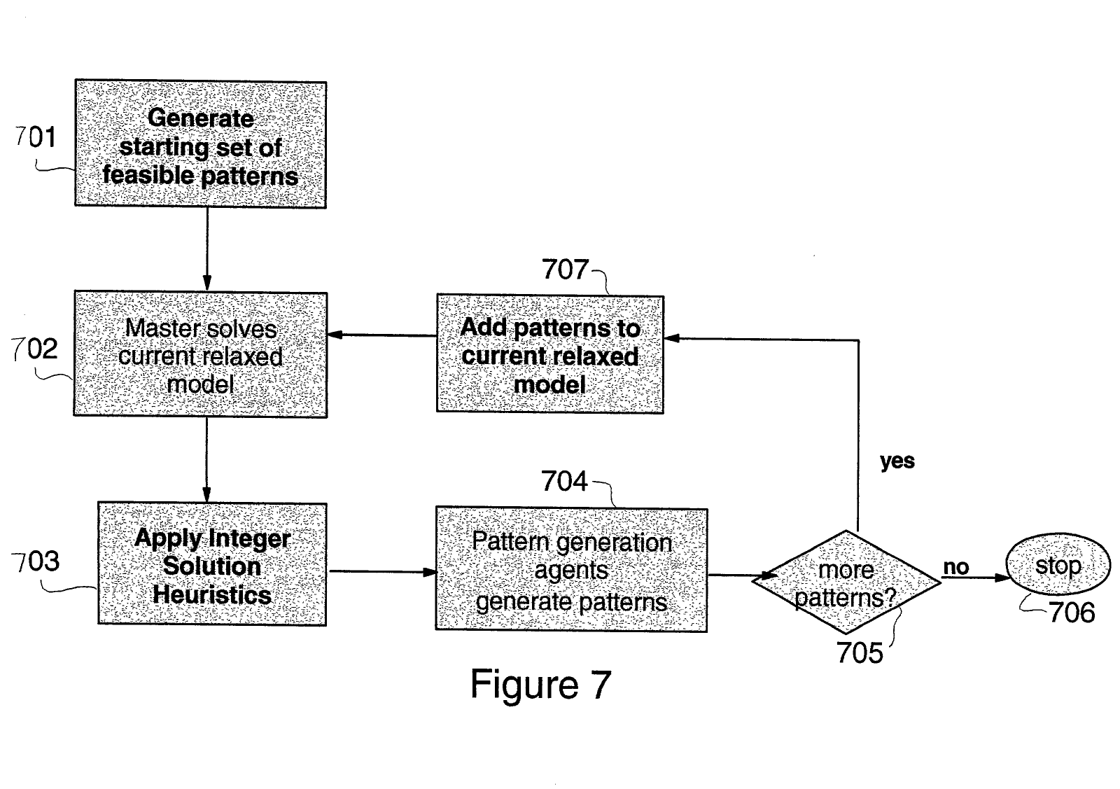

Referring now to FIG. 7, there is shown a flow diagram illustrating a high level outline of a distributed procedure in accordance with an embodiment of the present invention. As illustrated in FIG. 7, the distributed procedure starts in step 701 with the step of generating an initial set of supply patterns that represent the first set of current patterns 701. In step 702, the Master process takes the set of current supply patterns as an input and computes a cost-minimizing solution as well as market prices for the commodities and penalties/incentives for the business rules. The cost-minimizing solution calculated in step 702 provides the input to the application of the Integer Solution Heuristics in step 703. The market prices for the commodities and the penalties/incentives for the business rules are the inputs for the Pattern Generation Agents in step 704. The agents return supply patterns for inclusion in the current relaxed model in step 707. The iterative procedure terminates in step 706 when no additional patterns can be generated, as determined in step 705, or the solution is of acceptable quality. The quality is defined by the gap between the best integral solution found so far and a provable lower bound, as will be described below.

There are several techniques for initializing the set of current supply patterns in step 701. For example, one solution is to heuristically find a set of patterns that satisfy both the basic constraints and the business rules, but ignore the cost implications. A simpler solution is to introduce dummy suppliers who can supply any of the commodities at a very high cost (more than the highest price charged by any supplier for any commodity). These suppliers will be replaced by real suppliers in a few iterations unless the original problem was infeasible. It is contemplated that the procedure for initializing the set of current supply patterns in accordance with the present invention is but one example and may be implemented in many different ways known to one having ordinary skill in the art.

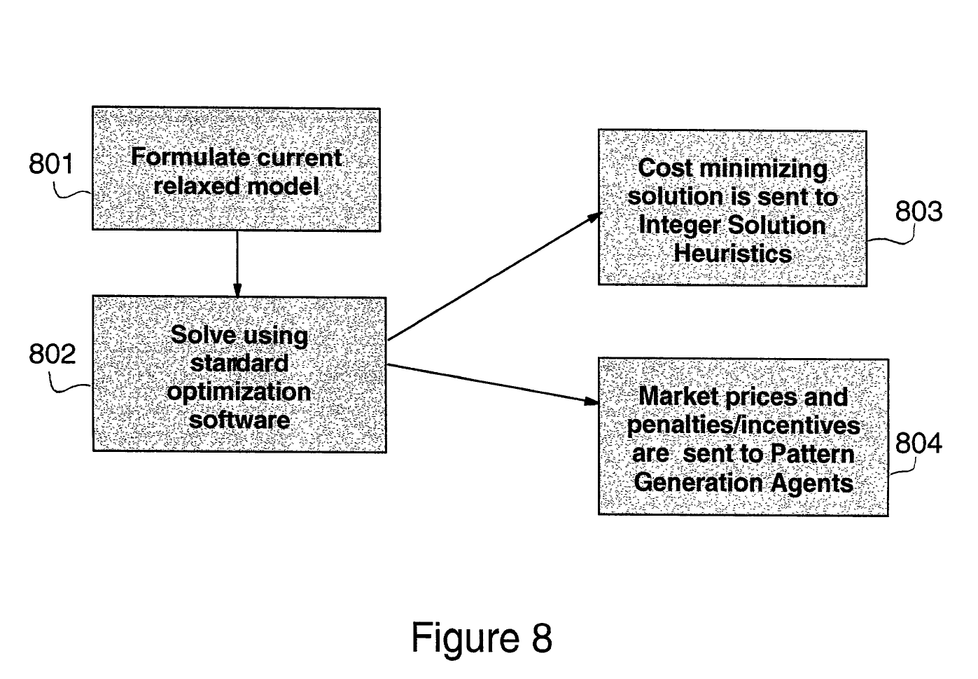

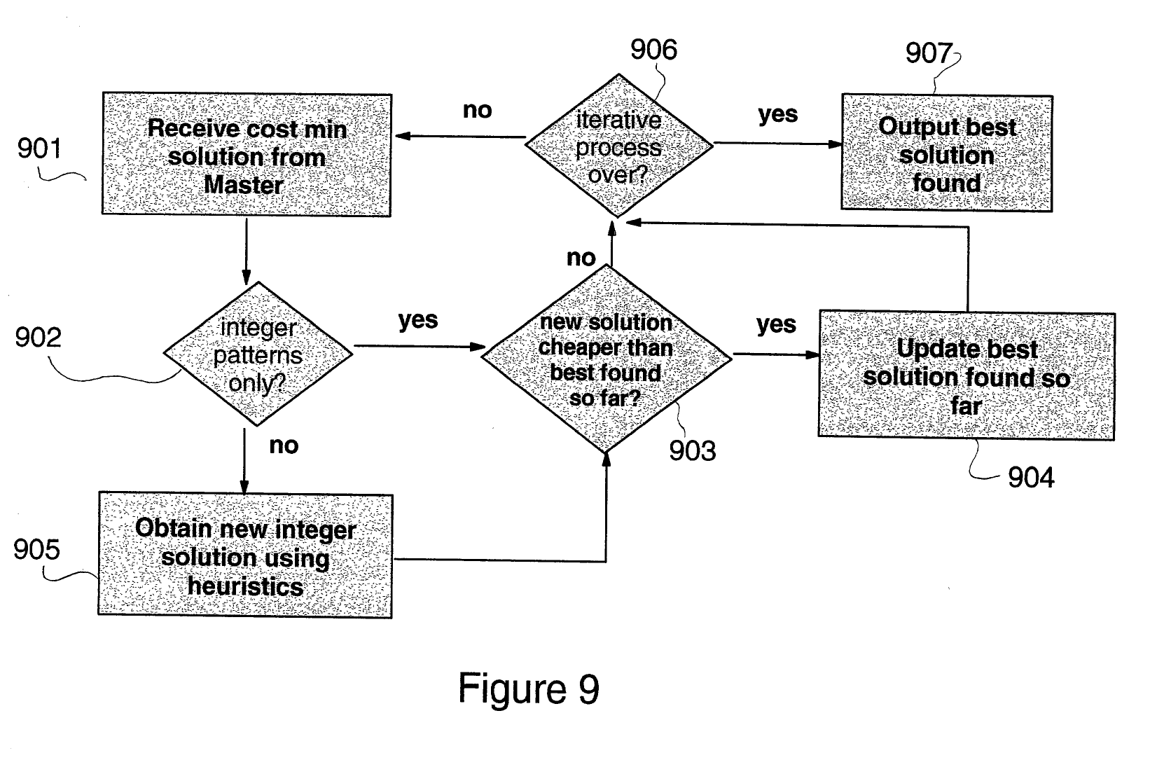

FIG. 8 is a flow diagram illustrating the flow of the Master process referred to above in step 702. Given the set of current supply patterns generated in step 701, the Master formulates a current relaxed model in step 801. The current relaxed model is a linear program with a manageable number of supply patterns and, thus, can be solved in step 802 using any standard optimization package such as the IBM Optimization Solutions and Library (OSL), ILOG CPLEX or XpressMP by Dash Optimization. The cost minimizing solution (primal solution to the linear program) is sent to the Integer Solution Heuristics in step 803 and is discussed further below in conjunction with FIG. 9. The market prices for the commodities and penalties/incentives for the business rules (the dual solution to the linear program) are the input for the Pattern Generation Agents as indicated in step 804.

The need for Integer Solution Heuristics arises because the cost minimizing solution produced by the Master process may contain some fractional-valued patterns. The pattern obtained by taking the specified fraction of the pattern may not be acceptable for the corresponding supplier since it might violate some business rules. For example, supplier A is providing 100 units of commodity 1 in a particular supply pattern. This pattern is chosen with a value of 0.1 in the cost minimizing solution. The pattern resulting from scaling all amounts in the pattern by 0.1 is not acceptable if a business rule requires this supplier to sell at least 50 units of commodity 1 for the supplier to sell any commodity at all. Even if the pattern obtained by scaling the original pattern by the appropriate fraction is acceptable, its cost will likely be different from the cost of the original pattern scaled by the fraction.

FIG. 9 is a flow diagram which depicts the process flow of the Integer Solution Heuristics. More specifically, as illustrated in FIG. 9, the Integer Solution Heuristics maintains the best integral solution found so far, along with its cost. As illustrated in step 901, the cost minimizing solution is received from the Master from step 803. As indicated in step 902, a check is performed to determine whether the cost minimizing solution received from the Master contains any fractional-valued patterns. If all patterns in the cost minimizing solution are integer-valued then, in step 903, the value of this solution is compared with the best (i.e., least expensive) value found so far to determine whether the new solution is less expensive than the best value found so far. The best solution and its value are updated in step 904 if the new solution is less expensive. Alternatively, if there are fractional-valued patterns then the Heuristics will attempt to find a solution with integer patterns only in step 905.

If an integer pattern is not found in step 902, a new integer solution using Heuristics is obtained in step 905, for instance, by rounding and using local improvement heuristics. Then, in step 903, the value of the solution found in step 905 is compared with the best solution found so far. Subsequent to this comparison and a possible update step, a determination is made in step 906 as to whether the iterative process is complete. When the iterative procedure is complete, as determined in step 906, the Heuristics will output the best solution found, in step 907. It is contemplated that the procedure for implementing the Integer Solution Heuristics in accordance with the present invention is but one example and may be implemented in many different ways known to one having ordinary skill in the art.

The process flow of the Pattern Generation Agent for a supplier is depicted in FIG. 10. In step 1001, the Agent receives, as an input, the current market prices for the commodities and penalties/incentives for the business rules from the Master in step 804. The supply curves submitted by the bidders are shown in step 1002, and the buyer imposed business rules that determine feasibility of the patterns are shown in step 1003. Note that the supply curves and the buyer imposed business rules illustrated in steps 1002 and 1003, respectively, were submitted in the beginning of the process and do not change during the iterative procedure. Thus, they need to be specified only once, i.e., before the Pattern Generation Agent is invoked for the first time. The goal of the Agent is to produce supply patterns with positive surplus for the suppliers at the current market prices or show that no such supply pattern exists. A way to achieve this goal is to process the current market data obtained in steps 1001, 1002 and 1003 to find the supply pattern with the most surplus in step 1004.

In step 1005, a determination is made as to whether the surplus from the pattern obtained in step 1004 is positive or negative. If the pattern surplus is positive, then the generated pattern is returned to the Master, as illustrated in step 1006. Otherwise, in step 1005, the Agent determines that no patterns with positive surplus exist. In either case, the Agent waits for the next set of inputs or for a signal that the iterative procedure is over.

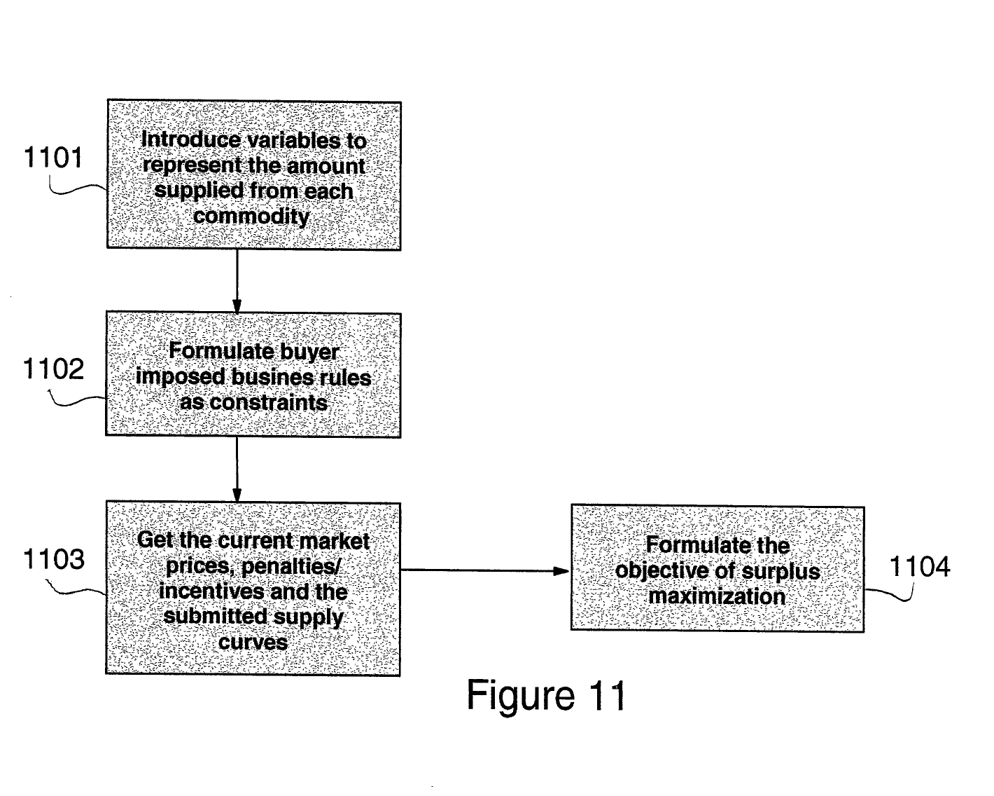

The Agent's task of finding a surplus maximizing supply pattern given the current market prices, referred to above as step 1004 in FIG. 10, can be formulated as a mathematical model as shown in FIG. 11. To formulate the mathematical model, in step 1101, first variables are introduced that represent the unknown quantities of the supplied commodities.

The terms xₗ^{j}, . . . , x_{K}^{j} represent the quantity supplied from each commodity in the pattern. In step 1102, the buyer imposed business rules are written as constraints in terms of these variables. The following equations illustrate the constraints corresponding to the business rules described above:

$${L}^{j} \leq {\sum }_{k} {x}_{k}^{j} \leq {U}^{j} and$$

where lₖ^{j} and uₖ^{j} are lower and upper limits on the amount that may be purchased from supplier j from commodity k, and L^{J} and U^{j} are lower and upper limits for this supplier across all commodities.

An objective of finding a surplus maximizing pattern in step 1104 can be expressed as:

$$max {\sum }_{k} {π}_{k} {x}_{k}^{j} + {ρ}_{j} + τ - {\sum }_{k} {p}_{k}^{j} ( {x}_{k}^{j} ) ,$$

where the positive terms in the objective represent the market value of the pattern with the penalties and incentives added (πₖ denotes the current market prices for the commodities, ρⱼ, τ, the incentives and penalties based on the supplier constraint and the buyer imposed business rules). The negative term represents the revenue from supplying the given pattern (the pₖ^{J}s are the submitted supply curves). Each of these terms are obtained in step 1103. The objective of finding a surplus maximizing pattern is computationally difficult in general because of the non-linearity of the objective. In accordance with the present invention a solution method for solving the objective is outlined.

To solve the Agent's problem, the variables xₖ^{J} are substituted by a set of SOS Type 2 variables to linearize the objective. The definition of an SOS type 2 set in optimization technology is known to one having ordinary skill in the art. An SOS type 2 set is a set of values wherein at most two neighboring values are nonzero. Solver packages, such as OSL, CPLEX and XpressMP handle SOS Type 2 sets.

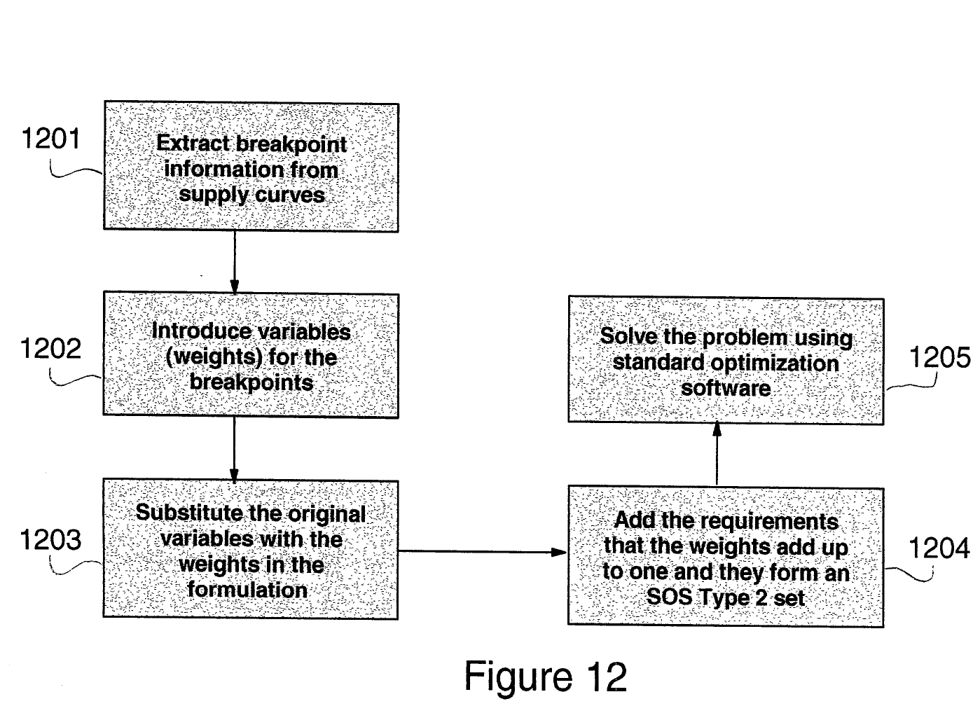

Referring now to FIG. 12, FIG. 12 illustrates the steps to be taken to linearize the above mathematical model. The piece-wise linear function pₖ^{j} is fully defined by a set of breakpoints bₖ₀^{J}, . . . , b_{kM}_{ₖ}_{^{J}}^{J}) and the values of the function at points pₖ^{J}(bₖ₀), . . . ,;ₖ^{J}(b_{jN}_{ₖ}_{^{J}}). The breakpoint information is extracted from supply curves in step 1201. Any value xₖ^{J} can be written as the convex combination of two neighboring breakpoints, and the value of the function pₖ^{j}( ) at xₖ^{J} can be written as the same convex combination of the values at these breakpoints because of the linearity of the price functions between the breakpoints. In step 1202, unknown weights 0≦λₖᵢ^{J}≦1 are introduced for the breakpoints and xₖ^{j} is defined in terms of the λₖᵢ^{J}s as

$${x}_{k}^{j} = {\sum }_{i} {λ}_{ki}^{j} {b}_{ki}^{j}$$

$${\sum }_{i} {λ}_{ki}^{j} = 1$$

wherein at most two neighboring λₖᵢ^{J}, i=1, . . . , Mₖ^{J} values are positive. The last requirement specifies, in step 1204, that the λₖᵢ^{j}s form an SOS Type 2 set for a given j and k. That is, a requirement is added such that the weights add to one and they form an SOS Type 2 set. The above construction is for continuous piece-wise linear functions. If the function is discontinuous, additional weights with values fixed to zero are assigned to the discontinuities. Single bid points (for instance, zero quantity for zero price) can be represented with one breakpoint and corresponding weight. The discontinuity can occur in a single point. In this case the two interval endpoints and the discontinuity will each be represented with separate weights. Substituting for the xₖ^{j}s in step 1203, the following model is obtained and is applied to resolve the agent's problem:

$$max {\sum }_{k} {\sum }_{i} ( {π}_{k} {b}_{ki}^{j} - {p}_{k}^{j} ( {b}_{ki}^{j} ) ) {λ}_{ki}^{j} + {ρ}_{j} + τ$$

$$s . t . {L}^{j} \leq {\sum }_{k} {\sum }_{i} {b}_{ki}^{j} {λ}_{ki}^{j} \leq {U}^{j}$$

$${l}_{k}^{j} \leq {\sum }_{i} {b}_{ki}^{j} {λ}_{ki}^{j} \leq {u}_{k}^{j}$$

$${\sum }_{i} {λ}_{ki}^{j} = 1$$

λₖᵢ^{j}s form an SOS Type 2 set for each k.

As indicated in step 1205, the optimization problem may be solved using standard optimization packages.

It is contemplated that the method in accordance with an embodiment of the present invention also provides tools to determine the quality of the best integral solution found so far, at any time during the optimization process. Preferably, a comparison is made between the value of the best feasible solution found so far and the value of the optimal solution to the full integral model. However, the latter value might not be determined during the solution process at all. The value of the full relaxed model is a lower bound on the value of the optimal solution, but this value will not be determined until the iterative process is complete. Although the value of the solution to the current relaxed model is known (i.e., it is solved by the Master), it is not necessarily a lower bound on the optimal value. Alternatively, using the current relaxed model and the supply patterns generated based on the results of the current relaxed model, a lower bound on the value of the solution to the full relaxed model can be determined and the value of the best feasible solution can be compared to the value of the solution to the full relaxed model.

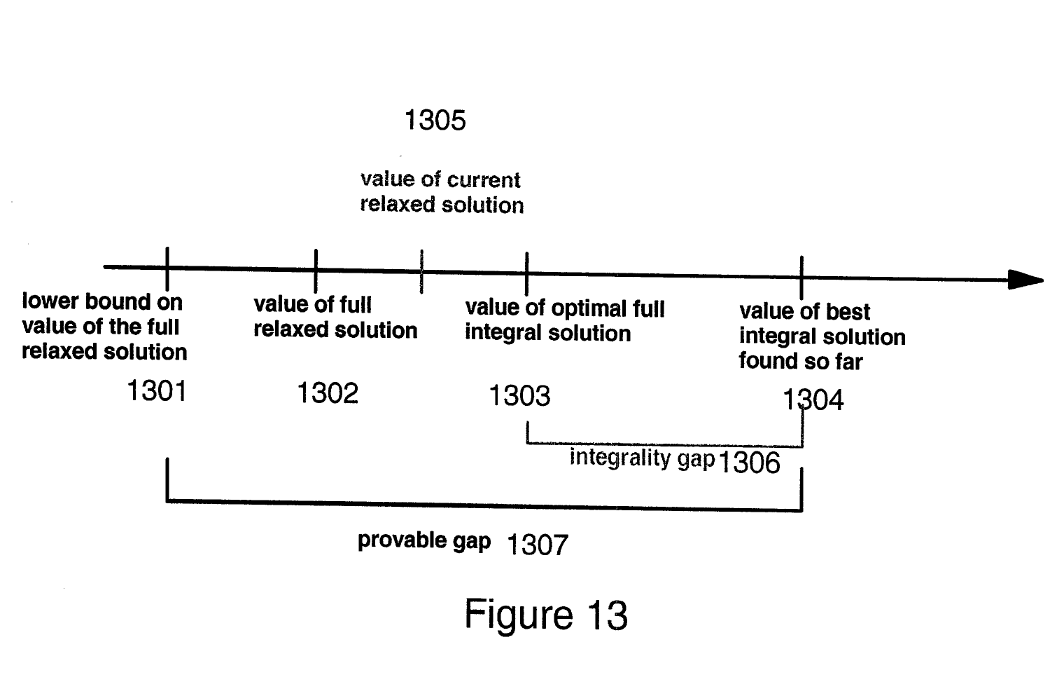

FIG. 13 is a line chart illustrating the relationship between various solution values during the iterative solution procedure. More specifically, the relationships between the various solution values, as illustrated in FIG. 13, are as follows: the lower bound on the full relaxed model 1301 is less than or equal to the value of the full relaxed model 1302 which is less than or equal to the optimal value of the full integral model 1303 which is less than or equal to the best integral solution found so far 1304. The value of the current relaxed model 1305 is always greater than or equal to the value of the full relaxed model 1302, but its relationship to the other values can vary. The integrality gap 1306 is defined as the distance between the value of the optimal full integral solution 1303 and the value of the best integral solution found so far 1304. The provable gap 1307 is defined as the distance of the lower bound on the value of the full relaxed solution 1301 and the value of the best solution found so far 1304. Therefore, as FIG. 13 indicates, the provable gap 1307 estimates the integrality gap 1306 from above. Thus, if the provable gap is small for a particular problem instance, so is the integrality gap.

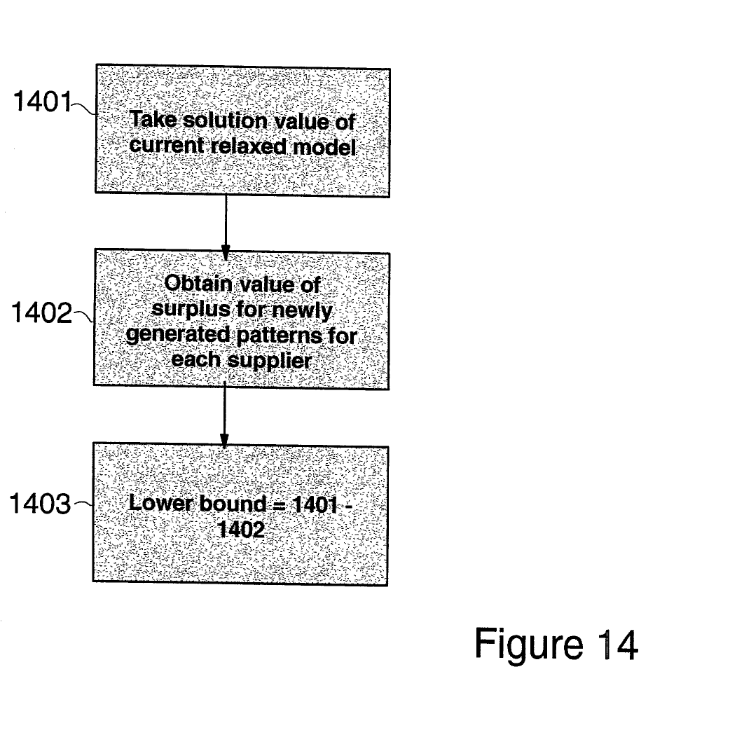

FIG. 14 is a flow diagram illustrating a method of computing the lower bound for the full relaxed master problem. As depicted in FIG. 14, to determine a lower bound on the value of the full relaxed model, the solution value of the current relaxed model is considered in step 1401, along with the sum of the surplus values of the recently generated surplus maximizing supply patterns in step 1402. Decreasing the solution value of the current relaxed model obtained in step 1401 by the value of the surplus obtained in step 1402 provides the resulting lower bound for the full relaxed master in step 1403. Alternatively, the lower bound for the full relaxed master value may be obtained by adding the values corresponding to all of the generated patterns to the current master problem at once. Note, however, that while the lower bounds obtained as in FIG. 14 in subsequent iterations of the bid evaluation procedure converge to the value of the full relaxed model, their sequence is not necessarily monotonically increasing.

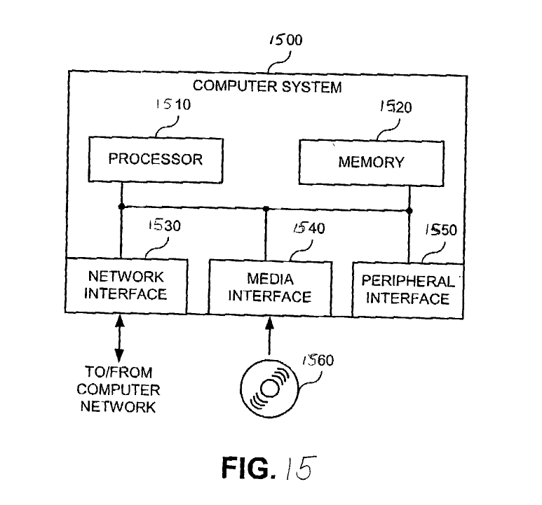

Turning now to FIG. 15, a block diagram is shown of a computer system 1500 for performing the methods and techniques of bid evaluation in accordance with an embodiment of the present invention. Computer system 1500 comprises a processor 1510, a memory 1520, a network interface 1530, a media interface 1540 and a peripheral interface 1550. Computer system 1500 is shown interacting with a Digital Versatile Disk (DVD) 1560 and a computer network. Network interface 1530 allows computer system 1500 to connect to a network (not shown), while media interface 1540 allows computer system 1500 to interact with media such as a hard drive or DVD 1560. Peripheral interface 1550 allows humans to interact with computer system 100 through peripheral devices such as (not shown) mice, keyboards, and monitors.

As is known in the art, the methods and apparatus discussed herein may be distributed as an article of manufacture that itself comprises a computer-readable medium having computer-readable code means embodied thereon. The computer-readable program code means is operable, in conjunction with a computer system such as computer system 1500, to carry out all or some of the steps to perform the methods or create the apparatuses discussed herein. The computer-readable medium may be a recordable medium (e.g., floppy disks, hard drives, optical disks such as DVD 1560, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic medium or height variations on the surface of a compact disk, such as DVD 1560.

Memory 1520 configures the processor 1510 to implement the methods, steps, and functions disclosed herein. For example, each of the different processes illustrated in the figures of the present invention may be stored in memory 1520. The memory 1520 could be distributed or local and the processor 1510 could be distributed or singular. The memory 1520 could be implemented as an electrical, magnetic or optical memory, or any combination of these or other types of storage devices. Moreover, the term “memory” should be construed broadly enough to encompass any information able to be read from or written to an address in the addressable space accessed by processor 1510. With this definition, information on a network, accessible through network interface 1530, is still within memory 1520 because the processor 1510 can retrieve the information from the network. It should be noted that each distributed processor that makes up processor 1510 generally contains its own addressable memory space. It should also be noted that some or all of computer system 1500 can be incorporated into an application-specific or general-use integrated circuit.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for evaluating bids, the method comprising the steps of:
obtaining at least one bid from a supplier, wherein the bid comprises data indicating a quantity of a commodity to be supplied and a cost of supplying the commodity;
generating at least one supply pattern from the bid; and
computing a cost associated with the supply pattern, wherein the cost is computed as a sum of costs for each commodity as specified by the supply pattern.

2. The method as recited in claim 1 further comprising the step of formulating a mathematical model for determining a set of cost minimizing supply patterns for the buyer.

3. The method as recited in claim 2 further comprising the step of applying decision variables to the supply patterns to indicate whether a supply pattern is acceptable.

4. The method as recited in claim 1 further comprising the step of evaluating the at least one supply pattern to determine whether it is acceptable, wherein the acceptability is a function of constraints set by the supplier and rules imposed by a buyer.

5. The method as recited in claim 4 wherein the evaluating step includes a constraint that requires a demand for the commodity to be satisfied and a constraint that requires that one supply pattern is chosen for each supplier.

6. The method as recited in claim 4 wherein the evaluating step includes a rule having an objective of minimizing the total cost of acceptable supply patterns and a business rule which limits a number of accepted suppliers to a predetermined number.

7. The method as recited in claim 1 further comprising the step of formulating an objective for use in evaluating the at least one bid.

8. The method as recited in claim 2 wherein the mathematical model comprises the steps of:
determining a cost-minimizing solution for a set of supply patterns in accordance with at least one buyer imposed business rule;
evaluating the acceptability of the cost-minimizing solution; and
maintaining a value associated with a best cost-minimizing solution found so far.

9. The method as recited in claim 8 wherein the steps of determining, evaluating and maintaining are repeated, thus creating an iterative procedure which determines and maintains the best cost-minimizing solution.

10. The method as recited in claim 8 wherein the determining step comprises the step of relaxing decision variables into continuous variables to determine the cost-minimizing solution.

11. The method as recited in claim 8 wherein the determining step comprises the step of computing a market price for each commodity as well as penalties and incentives based on the business rule.

12. The method as recited in claim 8 wherein the evaluating step is performed by an Integer Solution Heuristics program.

13. The method as recited in claim 12 further comprising the steps of:
obtaining information regarding current market prices, penalties and incentives; and
finding a surplus maximizing supply pattern given the current market prices, penalties and incentives.

14. The method as recited in claim 13 further comprising the step of solving the mathematical model by linearizing the at least one bid by replacing variables associated with the at least one bid with sets of SOS Type 2 variables and invoking a commercial solver package.

15. The method as recited in claim 1 further comprising the step of generating supply patterns for each supplier separately.

16. The method as recited in claim 13 further comprising the step of invoking an integer solution heuristics program and generating new supply patterns until a predetermined stopping criterion is satisfied.

17. The method as recited in claim 2 further comprising the steps of:
maintaining a best cost-minimizing solution from the set of cost-minimizing supply patterns;
comparing the set of cost-minimizing supply patterns with the best cost-minimizing solution; and
replacing the best cost-minimizing solution with the cost-minimizing supply pattern if the cost-minimizing supply pattern is less expensive than the best cost-minimizing solution.

18. An article of manufacture for evaluating bids in procurement auctions, the article comprising a machine readable medium containing one or more programs which when executed implement the steps of:
obtaining at least one bid from a supplier, wherein the bid comprises data indicating a quantity of a commodity to be supplied and a cost of supplying the commodity;
generating at least one supply pattern from the bid; and
computing a cost associated with the supply pattern, wherein the cost is computed as a sum of costs for each commodity as specified by the supply pattern.

19. The article of manufacture as recited in claim 18 further implementing the step of formulating a mathematical model for determining a set of cost minimizing supply patterns for the buyer.

20. The article of manufacture as recited in claim 19 further implementing the step of applying decision variables to the supply patterns to indicate whether a supply pattern is acceptable.

21. The article of manufacture as recited in claim 18 further implementing the step of evaluating the at least one supply pattern to determine whether it is acceptable, wherein the acceptability is a function of constraints set by the supplier and rules imposed by a buyer.

22. The article of manufacture as recited in claim 21 wherein the evaluating step includes a constraint that requires a demand for the commodity to be satisfied and a constraint that requires that one supply pattern is chosen for each supplier.

23. The article of manufacture as recited in claim 21 wherein the evaluating step includes a rule having an objective of minimizing the total cost of acceptable supply patterns and a business rule which limits a number of accepted suppliers to a predetermined number.

24. The article of manufacture as recited in claim 18 further implementing the step of formulating an objective for use in evaluating the at least one bid.

25. The article of manufacture as recited in claim 19 wherein the mathematical model comprises the steps of:
determining a cost-minimizing solution for a set of supply patterns in accordance with at least one buyer imposed business rule;
evaluating the acceptability of the cost-minimizing solution; and
maintaining a value associated with a best cost-minimizing solution found so far.

26. The article of manufacture as recited in claim 25 wherein the steps of determining, evaluating and maintaining are repeated, thus creating an iterative procedure which determines and maintains the best cost-minimizing solution.

27. The article of manufacture as recited in claim 25 wherein the determining step comprises the step of relaxing decision variables into continuous variables to determine the cost-minimizing solution.

28. The article of manufacture as recited in claim 25 wherein the determining step comprises the step of computing a market price for each commodity as well as penalties and incentives based on the business rule.

29. The article of manufacture as recited in claim 25 wherein the evaluating step is performed by an Integer Solution Heuristics program.

30. The article of manufacture as recited in claim 29 further comprising the steps of:
obtaining information regarding current market prices, penalties and incentives; and
finding a surplus maximizing supply pattern given the current market prices, penalties and incentives.

31. The article of manufacture as recited in claim 30 further comprising the step of solving the mathematical model by linearizing the at least one bid by replacing variables associated with the at least one bid with sets of SOS Type 2 variables and invoking a commercial solver package.

32. The article of manufacture as recited in claim 18 further implementing the step of generating supply patterns for each supplier separately.

33. The article of manufacture as recited in claim 30 further comprising the step of invoking an integer solution heuristics program and generating new supply patterns until a predetermined stopping criterion is satisfied.

34. The article of manufacture as recited in claim 19 further implementing the steps of:
maintaining a best cost-minimizing solution from the set of cost-minimizing supply patterns;
comparing the set of cost-minimizing supply patterns with the best cost-minimizing solution; and
replacing the best cost-minimizing solution with the cost-minimizing supply pattern if the cost-minimizing supply pattern is less expensive than the best cost-minimizing solution.

35. An apparatus for evaluating bids, the apparatus comprising:
a processor device; and
a memory device, wherein the processor device is configured to obtain at least one bid from a supplier, wherein the bid comprises data indicating a quantity of a commodity to be supplied and a cost of supplying the commodity; generate at least one supply pattern from the bid; and compute a cost associated with the supply pattern, wherein the cost is computed as a sum of costs for each commodity as specified by the supply pattern.
